(19) United States
(12) Patent Application Publication
(10) Pub. No.: US 2013/0014891 A1
(43) Pub. Date: Jan. 17, 2013

(54) Methods for manufacturing laminate panels

(71) Applicants: Christof VANDEVOORDE, Machelen-Zulte (BE); Benjamin CLEMENT, Waregem (BE)

(72) Inventors: Christof VANDEVOORDE, Machelen-Zulte (BE); Benjamin CLEMENT, Waregem (BE)

(21) Appl. No.: 13/543,185

(22) Filed: Jul. 6, 2012

(30) Foreign Application Priority Data
Jul. 12, 2011 (BE) 2011/0446

(51) Int. Cl. B32B 37/14; B32B 38/14

(52) U.S. Cl. 156/277

(57) ABSTRACT

A method for manufacturing a laminate panel with a substrate and a top layer includes the steps of printing a decor paper, composing a stack to be pressed from a substrate, and decor paper and one or more layers of synthetic material, and hot-pressing the stack. The paper to be printed or the printed paper, prior to the step of composing the stack, is provided with thermo-hardening or cross-linking resin wherein the resin is already at least partially hardened or cross-linked prior to the step of hot-pressing.

### BACKGROUND OF THE INVENTION

1. Field of the Invention

This invention relates to methods for manufacturing panels, as well as to panels obtained with such methods.

More particularly, the invention relates to a method for manufacturing laminate panels or panels having a laminated structure with at least a substrate and a provided thereon top layer on the basis of synthetic material, preferably on the basis of thermo-hardening material, such as melamine or another thermo-hardening amino resin.

2. Related Art

Such panels are known as such, for example, from the patent documents WO 03/095202, EP 1 290 290, DE 33 34 921 A1, WO 2008/148771 and WO 2009/080813. From the aforementioned patent documents, various techniques are known for manufacturing laminate panels.

Document EP 1 290 290, which forms the basis for the preamble of the appended claims, describes a method which is based on the traditional DPL (Direct Pressure Laminate) technique for manufacturing laminate panels comprising at least a substrate and a top layer. Such technique comprises at least the following steps:
the step of printing a decor paper;
the step of composing a stack to be pressed from a substrate, the aforementioned decor paper and one or more layers of synthetic material for forming a transparent layer above said decor paper; and
the step of hot-pressing said stack.

The particularity of a DPL technique is that the top layer or laminate layer is formed by consolidating at least the decor paper and the one or more layers of synthetic material. Consolidating comprises at least a hardening or cross-linking of the thermo-hardening synthetic material. At the same time, namely, by means of one and the same press treatment, this laminate layer is attached to the substrate. During this press treatment, by means of a structured press element a relief can be formed in the surface of the laminate panel. In the most frequently used DPL panels, the laminate layer is composed of a decor paper provided with thermo-hardening resin, and a provided there above transparent layer, which comprises thermo-hardening resin. With the known DPL technique, milky spots may occur in the transparent layer, a difficult to predict expansion of the decor paper may occur, and/or the scratch and/or wear resistance of the laminate surface leaves much to be desired. It is noted that an unpredictable expansion and instability of the decor paper is disadvantageous for obtaining a register between the motif of the decor paper and a relief which possibly is to be realized at the laminate surface.

From DE 33 34 921 A1, it is known to provide a thick layer of liquid adhesive on the substrate, with the intention of adhering a laminate plate thereto. Herein, this relates to a so-called HPL technique (High Pressure Laminate), wherein first a laminate plate is composed or consolidated from a plurality of paper webs provided with resin and wherein afterwards this laminate plate is adhered to a substrate. This technique, however, offers only limited possibilities for forming a relief on the laminate surface. The plurality of paper webs provided with resin leads to a less economic method than in the case of the above-mentioned DPL technique. Here, too, a difficult to predict expansion and instability of the decor paper may occur.

From WO 03/095202 and WO 2008/148771, similar techniques as in DE 33 34 921 A1 are known, however, for a DPL technique. In WO 03/095202, a resin-containing intermediate layer is applied between a decor paper and the substrate. The resin-containing intermediate layer can be free from filling agents, however, can also comprise a paper sheet or another material sheet. The resin of the intermediate layer is provided in a liquid manner. The decor paper either is or is not provided with resin; however, according to WO 03/095202, it has a certain remaining suction effect when performing the press treatment. An impregnated paper sheet is provided as a wear-resistant layer. The remaining suction effect of the decor paper can lead to a variable expansion and instability of the decor paper.

From WO 2009/080813, a technique is known wherein a laminate surface is composed of layers of synthetic, thermo-hardening material, which layers are applied in liquid form and are hardened in a press treatment. Similar techniques are known from DE 197 25 829 C1, WO 2011/076305 and EP 1 512 468.

### SUMMARY OF THE DISCLOSURE

The present invention aims at alternative methods for manufacturing panels with a laminated structure and, according to various independent aspects and possible embodiments thereof, offers advantages in respect to the state of the art.

To this aim, the invention, according to a first independent aspect, relates to a method for manufacturing a laminate panel comprising at least a substrate and a top layer, wherein the method comprises at least the following steps:
the step of printing a paper in order to form a decor paper;
the step of composing a stack to be pressed, comprising a substrate, said decor paper and one or more layers of synthetic material for forming a transparent or translucent layer above said decor paper, wherein the decor paper and the one or more layers of synthetic material substantially will form said top layer;
the step of hot-pressing said stack, wherein a consolidated whole of at least said substrate, said decor paper and said layers of synthetic material is created;
   with the characteristic that the paper to be printed or the printed paper, prior to the step of composing said stack, is provided with thermo-hardening or cross-linking resin, wherein said resin is already at least partially hardened or cross-linked prior to the step of hot-pressing. Preferably, the resin concerned is hardened before the decor paper is provided on the substrate, namely, preferably prior to the step of composing said stack to be pressed.

As a cross-linking or hardening of the resin-treated decor paper or paper to be printed is performed prior to the pressing step, the possible expansion of the paper concerned will be better under control. Moreover, the inventors have found that the presence of hardened resin in the decor paper, prior to the actual pressing, results in achieving laminate surfaces with improved wear resistance. This may be explained in that the possible hard particles present in the synthetic material of the transparent or translucent layer cannot penetrate or can penetrate less into the decor paper during the pressing step, whereby these particles remain more effectively operative as a wear-reducing means above the print of the decor paper. The cross-linking or hardening of the resin concerned also results in a reduction of the risk of the occurrence of so-called milky spots. This might be explained in that initially less moisture is present and/or less moisture is created by the cross-linking reaction in the layers to be pressed of the final top layer of the laminate panel. Initial moisture, and so-called chemical moisture, will form inclusions of fine vapor bubbles in the step of hot-pressing, which, as the inventors presume, are the cause of the occurrence of said milky spots.

From the above, it is clear that preferably at least one of said one or more layers of synthetic material for forming the transparent or translucent layer further comprises solid and/or hard particles, preferably hard particles. Generally, this herein preferably relates to hard particles which are harder than the synthetic material in which they finally will be situated in the panel. Preferably, this relates to ceramic particles, such as particles of aluminum oxide, silicon carbide or the like. Preferably, the particles have an average diameter situated between 20 and 200 micrometer, wherein an average diameter situated between 50 and 100 micrometer is preferred. When more than one, for example, at least two, of the layers of synthetic material comprise solid and/or hard particles, this preferably relates to at least two layers comprising hard particles of a same material, however, preferably of a different average diameter. Thus, for example, in a second layer, which preferably is located closer to the laminate surface, particles having a smaller average diameter can be applied, for example, having an average diameter situated between 15 and 45 micrometer.

Preferably, for the thermo-hardening resin of the decor paper, a resin on the basis of melamine is chosen, for example, melamine formaldehyde. Of course, the resin can contain one or more additives. As additives, flow improvers can be applied, such as polyglycol ether, epsilon-caprolactam, ethylene glycol, phthalic acid, phthalic acid ester or butane diol, hardening agents, such as maleic acid, monobutyl phosphoric acid, p-toluol sulfonic acid, citric acid, a mixture of one or more of these acids, aluminum sulfate, ammonium chloride or ammonium sulfate or other acids or salts which, when dissolved, result in an acid pH, release agents, and the like.

Said thermo-hardening resin preferably is diluted with water or with another, preferably organic, solvent, such that a mixture is obtained with 5 to 50 weight percent of solids content, or still better of 25 to 40 weight percent of solids content. According to a very interesting embodiment, for the resin of the decor paper an organic solvent-based melamine-based resin is applied, which contains as an additive at least a polyol, such as butane diol, polyurethane diol, a polyol acrylate or another hydroxy-functional acrylate. Such resin can be at least partially cross-linked or hardened, whereas still a sufficient processability of the decor paper or the paper to be printed is maintained. Working with hydroxy-functional acrylate, or in other words with an acrylate comprising an OH group, has the advantage that OH groups can be introduced in the melamine as the acrylate is dissolvable in melamine. It is clear that such additives, as mentioned herein above, can also be applied in water-based melamine-based resin. Compared to water-based resins, organic solvent-based resins have the advantage that they do not lead or lead less to swelling of the paper fiber, which as such results in a more stable decor paper which is less subject to expansion.

For example, 30-75 parts of weight of liquid melamine formaldehyde resin with, for example, 15 to 45 weight percent solids, 5-10 parts of weight of a polyol or a polyol acrylate and 2-3 parts of weight flow improving agent can be used.

Preferably, on the decor paper applied in the stack, there is a resin deposit of 2 to 20 grams of solid matter, of which, according to the first aspect, at least a portion is hardened or cross-linked prior to performing the step of hot-pressing. Preferably, the residual moisture content in the applied decor paper is less than 10 weight percent or still better less than 5 weight percent. The inventors have found that with the above-mentioned resin deposit, the suction effect of the decor paper can be maintained, whereas the dimensions of the decor paper remain approximately stable, or that at least any dimensional changes are much smaller, for example, are less than half or even less than a fifth than this is the case with untreated printed paper with the same moisture absorption. As the applied amount of resin is restricted, still a high-quality print can be obtained, if the latter should be performed afterwards, and/or still a sufficient adherence of the one or more layers of synthetic material for the transparent or translucent layer can be obtained. Possibly applying in liquid state at least one of said one or more layers of synthetic material of the transparent or translucent layer thus also will lead less to expansion of the underlying decor paper.

For the depositing the resin on the decor paper, preferably use is made of a doctor blade roller or other dosing device. The dosing device preferably allows adjusting the amount of resin to be applied within a tolerance of 2 grams per square meter.

Preferably, resin is deposited on both sides of the decor paper, for example, such that the total amount of deposited resin is situated between 2 and 20 grams per square meter.

Preferably, said hardening or cross-linking is obtained at least by performing a mechanical treatment of the paper provided with resin. Preferably, at least a press treatment is applied as a mechanical treatment. The inventors have found that performing a mechanical treatment, such as a press treatment, results in a more stable paper, which results in less unpredictable expansion. Such press treatment can or can not be performed at an increased temperature. In the case of increased temperature, preferably a temperature of more than 60°, more than 80°, and even still better a temperature of 110° or more is applied. Preferably, the mechanical treatment is performed on a paper web, for example, by means of a continuous press device. By a paper web, a longer stroke of paper is meant, which is supplied to the mechanical treatment device from on a spool and thus results in a continuous treatment of the paper which is moving through the device. However, it is not excluded that for the mechanical treatment, use shall be made of smaller paper sheets, the length of which, for example, is smaller than 10 times the width.

However, according to a deviating variant of the first aspect, it is not necessarily so that the resin provided on the decor paper must be at least partially cross-linked or hardened prior to the step of pressing. Preferably, the resin-treated paper indeed will be treated mechanically before being included into the stack, or preceding the step of pressing. So, for example, after drying of the resin deposit to a residual moisture content of less than 20, however, better of less than 10 weight percent, it can be pressed, for example, in a continuous press device or between rollers. The inventors have found that such pressing has a positive influence on the stability of the decor paper, whether a certain cross-linking has been obtained or not. During pressing, preferably a pressure of more than 0.5 MPa or still better of more than 1 MPa is applied.

Preferably, the aforementioned resin or a portion thereof has been provided on the paper to be printed prior to the step of printing. Preferably, the hardening or cross-linking of the respective resin has also been obtained prior to the step of printing. The possibility of making the paper in this manner already more stable before printing, is interesting in order to increase the register accuracy when offset printing, and/or to exclude possible expansion after printing, for example, when applying said one or more layers of synthetic material.

The decor paper, which is stabilized according to the first aspect of the invention, can be provided in the stack to be pressed according to different techniques. Thus, the step of composing said stack to be pressed preferably comprises applying the decor paper on the substrate, wherein to this aim one or a combination of two or more of the following techniques is applied:
the technique wherein an adhesive layer is provided on the substrate, and the decor paper is provided on the adhesive layer; wherein the adhesive layer can be hardened whether or not prior to the step of pressing. As an adhesive layer, a polyurethane-based glue can be applied, such as a polyurethane dispersion glue. Other possibilities for the adhesive layer are adhesive layers on the basis of hot-melt glues;
the technique wherein a thermo-hardening resin is provided on the substrate, either liquid or by means of a carrier sheet, such as a resin-treated paper sheet, above which the decor paper is placed. Preferably, this thermo-hardening resin is finally hardened only during the step of hot pressing. However, it is not excluded that a certain hardening will take place already prior to the step of hot-pressing;
the technique wherein the decor paper is adhered to the substrate by means of ionization;
the technique wherein the decor paper is adhered to the substrate by means of one or more welding connections. Such welding connection with the substrate can be realized by having the resin provided on the decor paper locally flow and harden again, for example, by means of a soldering iron or another heating device;
the technique wherein the decor paper is clamped to the substrate by means of a mechanical clamping connection.

Preferably, with each of the above techniques, however, not necessarily, already prior to the step of pressing an adherence to the substrate is obtained, which adherence is sufficient to maintain the mutual positioning between decor paper and substrate at least up into the step of pressing. Such technique allows adhering the decor paper with reference to a side and/or a corner point or another point of the substrate. Such reference then can be applied for providing a relief in the laminate surface in a suitable manner, for example, in order to adjust the whole to be pressed in respect of a structured press element applied in the press treatment, such as in respect to an etched and/or milled metal pressing plate. To this aim, for example, simply a stop rail can be used, against which the reference of the substrate is positioned. Hereby, cameras for adjusting the decor paper may become redundant.

It is clear that the invention of the first aspect preferably is applied for manufacturing laminate panels having at the laminate surface a relief of projections and/or recesses which correspond to the motif or pattern, provided by the print, on the decor paper. Instead of a relief or in combination therewith, different gloss degrees may also be applied in the laminate surface, which correspond to the motif of the print. In the case of a wood pattern, for example, a corresponding wood relief of, for example, wood pores, wood knots, bursts, silver grains or the like may be provided. Also, deepened edge regions, such as chamfers, imitations of tile joints, grout lines and the like can be impressed in a suitable manner along one or more sides of depicted wood panels or tiles. The invention allows obtaining a better correspondence in position between the print of the decor paper and the relief on the laminate surface. Hereby, it becomes also possible to imitate smaller relief characteristics in a suitable manner.

Preferably, at least one of said one or more layers of synthetic material is provided in the stack in a liquid manner, while the decor paper is already located on the substrate.

As already mentioned, preferably at least one of said one or more layers of synthetic material for forming the transparent or translucent layer further comprises solid and/or hard particles. For the synthetic material of these layers, preferably also a thermo-hardening resin, such as a melamine formaldehyde-based resin, is applied, which also can comprise one or more of the also above-mentioned additives. Preferably, here this relates to a water-based resin. In particular in combination with hard particles, the thermo-hardening resin further can also comprise chemical coupling agents, such as a silane-based coupling agent, which provides for an improved bond between hard particles, such as aluminum oxide, and melamine formaldehyde. So, for example, for 30-75 parts of weight of liquid resin, 2-5 parts of weight of coupling agent and 5-15 parts of weight of hard particles can be applied. Instead of providing the hard particles in the resin which has to be applied in liquid condition, they can also be deposited after providing the respective layer, for example, by means of a strewing device. Possibly, instead of a coupling agent provided in the liquid resin, or in combination therewith, also silane-encased hard part particles can be used.

In the case that said hard particles are provided on or in the respective layer of synthetic material by means of a strewing treatment, this preferably is performed while the decor paper is already situated on the substrate.

Preferably, at least one of said one or more layers of synthetic material, in the stack to be pressed, shows a cross-linking or hardening which is less than the cross-linking or hardening of the decor paper. Preferably, all layers of synthetic material in the stack to be pressed already show a certain hardening prior to the final hardening obtained in the stack of pressing.

Preferably, the transparent or translucent layer is composed of at least 3 or at least 4 resin layers deposited in liquid condition.

Preferably, the layers of synthetic material are provided successively and each time an at least partial hardening or cross-linking takes place before a subsequent layer is applied. Preferably, for applying one or more of the layers of synthetic material, a roller device is used, followed by a drying device.

Preferably, also on the underside of the substrate one or more layers of synthetic material, preferably also a thermo-hardening resin, is deposited in order to form a vapor-tight and/or water-tight layer. These one or more layers lead to creating a balancing effect for compensating possible residual tensions in the top layer. For realizing such backing layer, use can be made of the techniques described in WO 2010/084466, wherein a paper-free balancing layer is obtained on the basis of liquidly applied polycondensating resin. However, it is not excluded that for the backing layer or balancing layer, use might be made of a resin-provided carrier sheet, such as a paper sheet, which is taken up in the stack to be pressed on the underside of the substrate. For the adherence of the paper sheet on the underside of the substrate, similar techniques can be applied as for the adherence of the decor paper.

With the same aim as in the first aspect, the invention, according to an independent second aspect, relates to another method for manufacturing a laminate panel comprising at least a substrate and a top layer, wherein the method comprises at least the following steps:
the step of printing a paper in order to form a decor paper;
the step of composing a stack to be pressed, comprising a substrate, said decor paper and one or more layers of synthetic material for forming a transparent or translucent layer above said decor paper, wherein the decor paper and the one or more layers of synthetic material substantially will form said top layer;
the step of hot-pressing said stack, wherein a consolidated whole of at least said substrate, said decor paper and said layers of synthetic material is created;
   with the characteristic that the paper to be printed or the printed paper, prior to the step of composing said stack, is provided with thermo-hardening or cross-linking resin and that at least one of said one or more layers of synthetic material is provided in the stack in liquid manner, while the decor paper is already situated on the substrate. As the decor paper already comprises resin, providing synthetic material in a liquid manner will have less influence on the stability of the decor paper.

Preferably, the decor paper, according to this second aspect, is saturated with resin and/or comprises, compared to its dry paper weight, between 100 and 300 percent of solid matter of resin. In other words, a decor paper with an own surface weight of, for example, 80 grams per square meter, in the stack to be pressed, has a surface weight, including the resin deposit, of 160 to 320 grams per square meter.

Preferably, at least at both flat sides of the decor paper, according to this second aspect, a layer of resin is situated.

It is clear that the method of the second aspect can be performed in combination with the method of the first aspect or the preferred embodiments thereof. However, according to the second aspect, it is not necessarily so that the resin provided on the decor paper must at least be partially cross-linked or hardened prior to the pressing step. Preferably, the resin-treated paper in fact will be treated mechanically before being taken up in the stack or prior to the pressing step. So, for example, after drying of the resin deposit to a residual moisture content of less than 20, but still better of less than 10 weight percent, it can be pressed, for example, in a continuous press device or between rollers. The inventors have found that such pressing has a positive influence on the stability of the decor paper, whether or not any cross-linking is obtained.

With the same aim as with the first and the second aspect of the invention, the invention, according to an independent third aspect, relates to another method for manufacturing a laminate panel comprising at least a substrate and a top layer, wherein the method comprises at least the following steps:
the step of printing a paper in order to form a decor paper;
the step of composing a stack to be pressed, comprising a substrate, said decor paper and one or more layers of synthetic material for forming a transparent or translucent layer above said decor paper, wherein the decor paper and the one or more layers of synthetic material substantially will form said top layer and at least one of said one or more layers comprises solid and/or hard particles;
the step of hot-pressing said stack, wherein a consolidated whole of at least said substrate, said decor paper and said layers of synthetic material is created;
   with the characteristic that said particles are provided on or in the respective layer of synthetic material by means of a strewing treatment, while the decor paper is already situated on the substrate. By performing the strewing treatment while the decor paper is already situated on the substrate, the strewing is performed on a rigid subsurface, and in this manner a more uniform strewing pattern can be obtained than this may be the case, for example, when strewing on a paper web. Strewing devices suitable for such application are known as such, for example, from GB 1,035,256.

It is clear that the decor paper, according to the third aspect, when being provided in the stack to be pressed, can be free from any resin deposit or other substances. When the decor paper nevertheless should be provided with resin, this does not necessarily have to be already partially cross-linked or hardened prior to the pressing step, as this is the case in the first aspect. Preferably, the third aspect is combined with said second aspect, wherein then preferably it is strewn in one or more layers provided in liquid manner. Of course, the third aspect of the invention can also be combined with the first aspect.

It is self-evident that, when a plurality of layers for forming the transparent or translucent layer comprise hard particles, these hard particles do not necessarily have to be applied in the layer in the same manner. A combination can be made of suspended hard particles provided in the liquidly provided resin and strewn hard particles.

According to all aspects, the aforementioned substrate preferably relates to an MDF or HDF board and/or the aforementioned decor paper has a surface weight of 45 to 120 grams per square meter in untreated and unprinted condition, and preferably a surface weight situated between 45 and 90 grams per square meter. A similar surface weight can be applied for the possible paper of a possible balancing layer.

Immediately before the pressing step, the substrate preferably has a residual moisture content between 5.5 and 10%, or better between 7 and 9%. Hereby, once again the moisture in the stack is restricted, which will result in less formation of milky spots in the laminate surface. Moreover, such residual moisture content leads to a minimization of crimp effects and other annoying dimensional deformations, such as warping. Hereby, in its turn the amount of resin in the possible balancing layer can be limited.

Preferably, a substrate is used which, at its surface, where the top layer is provided, has a density of more than 800 kilograms per cubic meter, or even of more than 900 kilograms per cubic meter. It is in particular with such substrates that the problems of milkiness can be prominent, as in the step of hot-pressing then mostly a higher pressure is applied, such as a pressure of more than 2 MPa or even higher than 4 MPa.

According to all steps, in said pressing step preferably a relief or surface structure is realized at the surface of the laminate panels. Preferably, said substrate remains free from local deformation. Preferably, the applied pressing pressure herein is less than 60 bar (6 MPa) or even less than 40 bar (4 MPa). The applied pressing temperature preferably is higher than 100° C. and may amount to 200° C. The required pressing temperature can be influenced by applying the already above-mentioned hardening catalysts or hardening agents. By means of the above press parameters, a pressing time situated between 12 and 32 seconds can be sufficient, preferably a pressing time situated between 17 and 25 seconds can be applied.

According to all aspects, the invention preferably is applied for manufacturing laminate panels which, at least at one edge and preferably at least at two opposite edges, are provided with a lower-situated edge region, such as a chamfer, wherein said decorative material sheet extends uninterruptedly on the surface of the lower-situated edge region, the chamfer or chamfers, as well as on the actual surface of the laminate panel. Such lower-situated edge region or chamfer can be obtained in that in the press treatment of said pressing step, by means of a press element applied herein, an impression is provided at the location of the final edge of the laminate panel. It is clear that the press treatment of the respective aspects first can be performed on a larger board, from which, by dividing it, a plurality of laminate panels can be obtained. Finally, this may relate to floor panels, ceiling panels, wall panels or furniture panels, which are cut by two or more from such larger board.

According to all aspects and deviating variants, the press treatment from the pressing step preferably relates to a press treatment by means of an opening and closing press, namely a so-called Kurztaktpresse or single-daylight press. Hereby, preferably a press element in the form of a structured press platen is applied. During said press treatment, the structure of the press platen is copied into the surface of the laminate panels. For examples of possible press platens, reference is made to WO 2006/066776.

According to all aspects of the invention, it is preferably avoided that in the uppermost layer of said stack a layer of synthetic material is applied which comprises hard particles. To this aim, for example, as the last layer of the stack use can be made of contactless-applied synthetic material, such as said preferably thermo-hardening resin, such as melamine resin, which preferably is free from hard particles. In this manner, exposed hard particles of underlying layers still will be covered by a layer of softer synthetic material. This is of particular importance when the hard particles are provided at least partially or at least in one layer by means of a strewing device. When applying such technique, the hard particles namely rather will be situated at the surface of the respective layer. For contactless application of synthetic material, an atomizing, splattering or spraying device can be opted for. By working with a last layer of contactless-applied synthetic material, the rate of wear of a possible press element, which is applied in the step of hot-pressing, can be restricted. Contactless application avoids excessive interference with the surface of the stack to be pressed. A small amount of additional synthetic material, applied in this layer, can suffice. For example, this may relate to less than 10 grams per square meter, or even to less than 5 grams per square meter, of solid matter.

It is clear that within the scope of the present invention, by thermo-hardening is meant that the respective material hardens irreversibly when heat is supplied. This is contrary to thermoplastic materials, which allow melting. Preferably, for the thermo-hardening material a material is used which hardens by polycondensation. Instead of melamine-based resin, for the polycondensating material also urea or melamine-urea-based resin can be applied, such as urea formaldehyde or melamine urea formaldehyde.

According to all steps of the invention, in the step of printing in order to form the decor paper, preferably a printing process is applied which makes use of printing cylinders, for example, an offset printing process. The problem of adjusting and holding printing cylinders in register is known. The present invention offers various possibilities for more smoothly achieving the so-called register accuracy, for example, by providing the paper to be printed with an amount of cross-linked or hardened resin. To their surprise, the inventors have found that it is possible to perform high-quality printing on such treated paper. Preferably, a mechanical treatment of the paper to be printed by means of a pressing device is applied. Of course, it is not excluded that for printing, any other printing technique might be used, such as digital printing, for example, by means of one or more inkjet print heads. Preferably, in all these embodiments and independently from the printing process, water-based or solvent-based inks are used. In the case of water-based inks, this preferably relates to inks containing pigments. The inventors have found that such inks render the best result in combination with thermo-hardening resin. Of course, applying UV-based inks is not excluded. In the cases in which the resin of the decor paper is provided on the paper still to be printed, preferably also use is made of a primer, which is provided on that side of the paper which must be printed, before the print is performed.

According to all aspects of the invention, finally in the top layer of the panel an amount of synthetic material, preferably thermo-hardening material, is applied, which preferably is situated between 30 and 200 grams per square meter, or still better is situated between 50 and 150 grams per square meter of dry weight. For a possible backing layer or balancing layer, the same limits may be applied, which does not necessarily have to result in an equally large amount of resin. Preferably, the resin amount in the balancing layer deviates maximum 20 percent from the amount of resin in the top layer.

Generally, the invention, as already mentioned in respect to the first aspect, also according to all of its remaining aspects can be applied usefully for manufacturing laminate panels which, at the laminate surface, show a relief of projections and/or recesses which correspond to the motif or pattern provided on the decor paper by the print. Instead of a relief or in combination therewith, also different gloss degrees can be applied in the laminate surface, which correspond to the motif of the print.

With the intention of better showing the characteristics of the invention, hereafter, as an example without any limitative character, some preferred embodiments are described, with reference to the accompanying drawings, wherein:

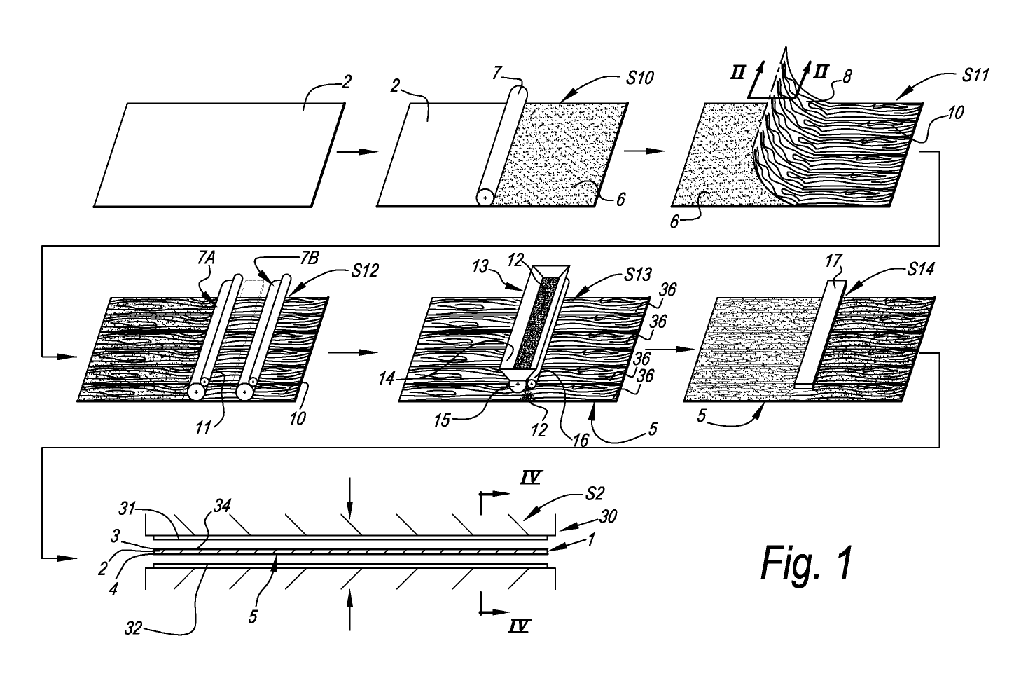

FIG. 1 schematically represents some steps of a method having the characteristics of the invention;

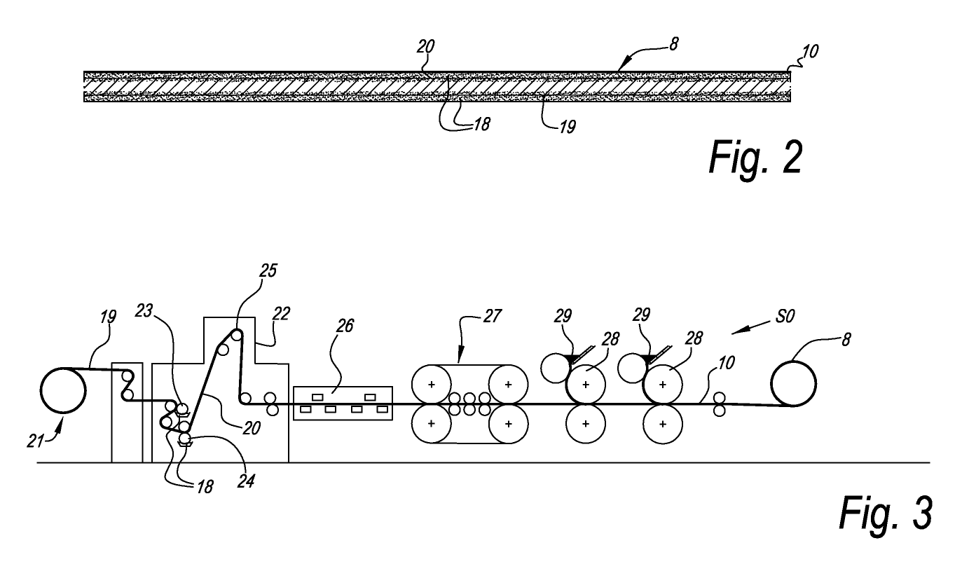

FIG. 2, at a larger scale, represents a cross-section according to the line II-II indicated in FIG. 1;

FIG. 3 schematically represents an example of the step of printing in a method having the characteristics of, for example, the first aspect of the invention;

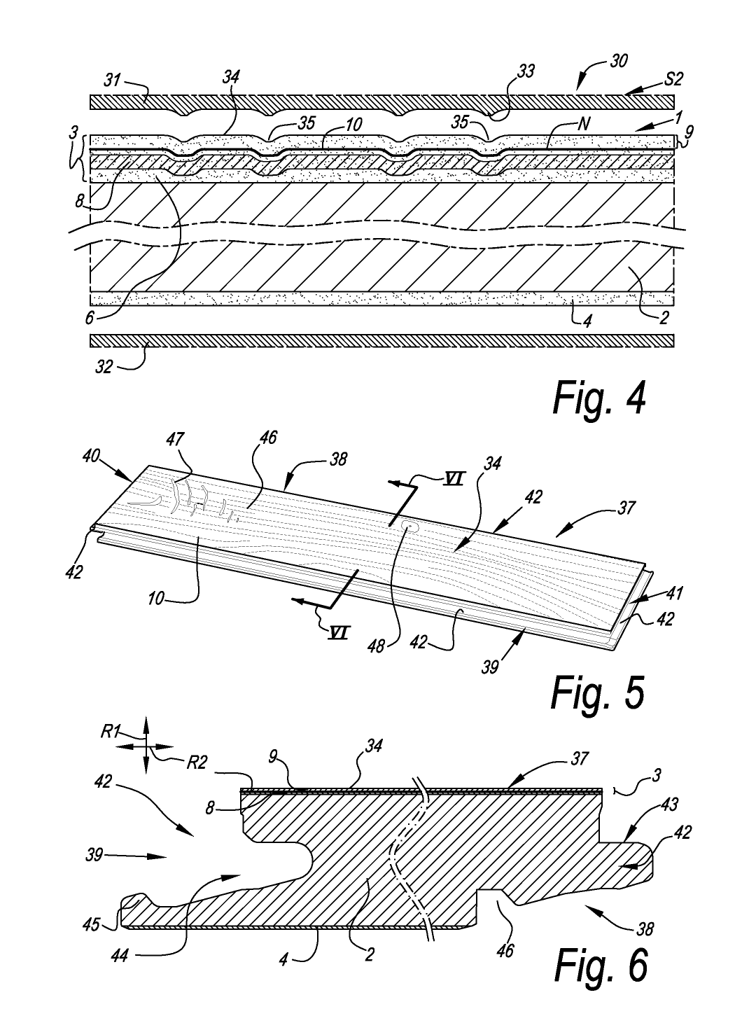

FIG. 4, at a larger scale, represents a cross-section according to the line IV-IV indicated in FIG. 1;

FIG. 5 in perspective represents a laminate panel which is obtained by means of a method according to the invention; and

FIG. 6, at a larger scale, represents a cross-section according to the line VI-VI represented in FIG. 5.

FIG. 1 represents a method for manufacturing a laminate panel 1. The laminate panel 1 comprises a substrate 2 and a top layer 3. In the example, also a balancing layer 4 or backing layer is applied on the underside of the substrate 2.

FIG. 1 represents that the method comprises at least the step of composing a stack 5 to be pressed. In this case, said step comprises a plurality of partial steps S10-S11-S12-S13-S14-S15.

In the partial step S10, an adherence layer 6 is provided on the substrate 2, for example, an adhesive layer or a layer of liquidly applied thermo-hardening resin. In the example, a roller device 7 is applied for this purpose.

In the partial step S11, a decor paper 8 is taken up in the stack 5. To this aim, said decor paper 8 is provided on the adherence layer 6. This can be performed, for example, by means of a laminating device (German: Kaschieranlage), which is not represented here.

In the partial step S12, one or more, in this case two, layers of synthetic material, for example, thermo-hardening resin, are provided for forming a transparent or translucent layer 9 above the print 10 of the decor paper 8. In the example, both layers are provided in liquid manner by means of roller devices 7A-7B. Intermediate drying by means of the drying device 11 represented in dashed line, with or without the occurrence of cross-linking, can take place between any two of such roller devices 7A-7B, such as here, or after each roller device 7A-7B. Preferably, at least 3 and still better at least 4 of such layers of synthetic material are applied, preferably each time with a drying after each roller device. Possibly, for one or more of these layers, use can be made of a synthetic material in which hard particles are suspended. Preferably, the supply conduits to such roller devices are cooled in order to avoid any sticking of resin in the conduits and the roller devices.

In the partial step S13, hard particles 12 are provided in a layer of synthetic material by means of a strewing treatment, and such while the decor paper 8 is already situated in the stack 5, on the substrate 2. As such, the method depicted here shows the characteristics of the third aspect of the invention. The strewing device 13 applied here comprises a receptacle 14, from which hard particles 12 are provided on a roller 15, preferably a structured roller, such as an anilox roller. Then the hard particles 12 are removed from the roller 15 in order to spread them as uniformly as possible over the surface of the layer of synthetic material. In this case, use is made of a rotating brush 16 for loosening the hard particles from the roller 15. However, use can also be made of vibrations of the roller 15, of a brush moving to and fro, or even of electric attraction in order to loosen the hard particles 12.

In the partial step S14, a small amount of synthetic material is applied as the last layer of the stack. Here, this is performed contactless, for example, by means of a spraying device 17.

FIG. 1 further also shows that the method also comprises the step S2 of hot-pressing the stack 5. Hereby, the finally consolidated whole of the laminate panel 1, or at least substantially, is obtained, wherein the top layer 3 of this laminate panel 1 then is composed of the mutually connected adherence layer 6, decor paper 8 and the layers of synthetic material of the transparent or translucent layer 9.

In FIG. 2 is represented that the decor paper 8, prior to the step S11, is provided with thermo-hardening or cross-linking resin 18. Thus, the method of the example also shows the characteristics of the second aspect of the invention mentioned in the introduction. As already mentioned, according to this second aspect at least one, and in this case two, of the layers of synthetic material for forming the transparent or translucent layer is brought into the stack in liquid manner, namely by means of the roller devices 7A-7B, while the decor paper 8 is already situated in the stack 5 and on the substrate 2.

The embodiment of FIG. 2 further is special in that an amount of resin 18 is provided on the upper side 19 as well as on the underside 20 of the decor paper 8. It is clear that this resin 18 can manifest itself as effective layers on the exterior sides of the paper as well as can be situated substantially within the paper. Preferably, at least a certain impregnation of the paper itself is obtained. Preferably, at least thirty percent or still better at least half of the entire thickness of the paper is impregnated with resin. How the resin 18 precisely is present on or in the decor paper 8, depends on the application method thereof and the possible mechanical treatment of the decor paper 8 provided with resin 18. For a possible application method, reference is made to FIG. 4.

FIG. 3 represents how an application of resin 18 on the decor paper 8 might take place in practice. FIG. 3 represents an example of an application of resin 18 prior to the step S0 of printing the decor paper 8, wherein finally a resin-treated decor paper 8 is obtained, similar to that of FIG. 2. It is started from a roll 21 of raw paper. This roll 21 is unwound and lead through a resin-treatment device 22 in a continuous manner. Herein, by means of two doctor rollers 23-24, an amount of resin 18 is provided both on the underside 19 and on the upper side 20 of the paper. The resin 18 gets the time to impregnate somewhat into the paper during the movement thereof over the airing rollers 25. In this case, the resin 18 is an organic solvent-based melamine resin. Thereafter, it moves further through a drying device 25, in this case, a hot-air oven. Of course, it may also be opted for an infrared drying device. It can be chosen for already having a certain cross-linking or hardening of the resin 18 occur in this drying device. The impregnated paper then passes through a continuous pressing device 27 and will be subjected to a mechanical treatment there.

Prior to the step S0 of printing, already a hardening or cross-linking of a portion of the resin 18 is obtained. It is clear that in such case, an embodiment of the first aspect of the invention is obtained, as the hardening is obtained prior to the step S11 of composing the stack 5 to be pressed.

For the step S0 of printing, here it is chosen for an offset printing process by means of a plurality of printing cylinders 28. Although only two printing cylinders 28 are represented here, preferably between 3 and 6 cylinders are applied. For the ink 29, preferably a water-based ink with pigments is applied. After the printing process, the obtained decor paper 8 is wound again, as represented here. However, it can also be cut to sheets, whether or not after having been wound.

FIG. 4 represents that in the step S2 of hot-pressing, an opening and closing press device 30 can be applied, wherein the stack 5 is pressed between an upper press element 31 and a lower press element 32. The upper press element 31 is made structured and comprises projections 33, which are intended for forming recesses 35 in the surface 34 of the laminate panel 1. By means of such recesses 35, preferably a relief is formed which, in position and size, corresponds to characteristics of the print 10 on the decor paper 8. The inventors have found that according to the invention relatively deep recesses 35 can be provided in the surface 34 of the laminate panel 1, for example, recesses 35 which penetrate up into the decor paper 8 without the occurrence of milky spots in the transparent or translucent layer 9. By “penetrate up into the decor paper 8” is meant that the print 10 is no longer situated in a horizontal plane, but, possibly only locally, at the location of one or more recesses 35, plunges below the level N of the horizontal plane in which the print 10 globally extends. As mentioned in the introduction, such recesses 34 can form an imitation of wood pores or other wood structures, or they can form lower-situated edge portions.

In respect to FIG. 4, it is also noted that in this example a paper-free backing layer 4 is applied.

In respect to the print 10, a print 10 with a wood motif can be applied, as in the examples of the figures. As represented, this relates to a print representing the images 36 of a plurality of wooden panels. In this case, the obtained laminate panel 1 is intended for being subdivided for obtaining a plurality of floor panels 37, such as those represented in FIG. 5. In this case, this relates to an oblong floor panel 37 with a pair of long sides 38-39 and a pair of short sides 40-41, wherein on at least one pair of sides, however, in this case on both pairs of sides, coupling means 42 are provided, which allow that two of such floor panels 1, at the respective edges, can be brought into a coupled condition, wherein they are mutually locked in a vertical direction R1 perpendicular to the plane of the coupled panels 1, as well as in a horizontal direction R2 perpendicular to the coupled edges and in the plane of the floor panels 1. Such coupling means 42 or coupling parts as such are well known, for example, from WO 97/47834.

FIG. 6 represents that the coupling means 42 substantially can be realized as a tongue 43 and groove 44, which, for obtaining the locking in horizontal direction R2, are provided with cooperating locking parts 45.

It is also noted that the print 10 of the floor panel 37 of FIG. 5 represents some characteristic features of wood patterns, such as wood pores 46, wood silver grains 47 and wood knots 48. It is evident that by means of the invention, a suitable relief and/or a suitable gloss degree can be obtained in the surface 34 of the floor panel 37 at the location of these features.

The present invention is in no way limited to the herein above-described embodiments; on the contrary, such methods can be realized without leaving the scope of the present invention.

1-11. (canceled)

12. Method for manufacturing a laminate panel comprising at least a substrate and a top layer, wherein the method comprises the following steps:
printing a paper in order to form a decor paper;
composing a stack to be pressed, comprising a substrate, said decor paper and one or more layers of synthetic material for forming a transparent or translucent layer above said decor paper, wherein the decor paper and the one or more layers of synthetic material substantially will form said top layer;
hot-pressing said stack, wherein a consolidated whole of at least said substrate, said decor paper and said layers of synthetic material is created;
wherein the paper to be printed or the printed paper, prior to the step of composing said stack, is provided with thermo-hardening or cross-linking resin, wherein said resin is already at least partially hardened or cross-linked prior to the step of hot-pressing.

13. The method of claim 12, wherein said hardening or cross-linking is at least obtained by performing a mechanical treatment of the paper provided with resin.

14. The method of claim 12 or 13, wherein said resin is provided on the paper to be printed prior to the step of printing.

15. The method of claim 14, wherein the hardening or cross-linking of the respective resin is also obtained prior to the step of printing.

16. The method of claim 12 or 23, wherein the step of composing said stack to be pressed includes applying the decor paper on the substrate, wherein one or a combination of two or more of the following techniques is applied:
the technique wherein an adhesive layer is provided on the substrate, and the decor paper is provided on the adhesive layer; wherein the adhesive layer can be hardened whether or not prior to the step of pressing;
the technique wherein the decor paper is adhered to the substrate by means of ionization;
the technique wherein the decor paper is adhered to the substrate by means of one or more welding connections;
the technique wherein the decor paper is clamped to the substrate by means of mechanical clamping connections.

17. The method of claim 12 or 13, wherein at least one of said one or more layers of synthetic material are provided in the stack in a liquid manner, while the decor paper is already situated on the substrate.

18. The method of claim 12 or 13, wherein at least one of said one or more layers of synthetic material further comprises solid and/or hard particles.

19. The method of claim 18, wherein said particles are provided on or in the respective layer of synthetic material by means of a strewing treatment, while the decor paper is already situated on the substrate.

20. Method for manufacturing a laminate panel, comprising at least a substrate and a top layer, wherein the method comprises the following steps:
printing a paper in order to form a decor paper;
composing a stack to be pressed, comprising a substrate, said decor paper and one or more layers of synthetic material for forming a transparent or translucent layer above said decor paper, wherein the decor paper and the one or more layers of synthetic material substantially will form said top layer;
hot-pressing said stack, wherein a consolidated whole of at least said substrate, said decor paper and said layers of synthetic material is created;
wherein the paper to be printed or the printed paper, prior to the step of composing said stack, is provided with thermo-hardening or cross-linking resin, and that at least one of said one or more layers of synthetic material are provided in the stack in a liquid manner, while the decor paper is already situated on the substrate.

21. Method for manufacturing a laminate panel, comprising a substrate and a top layer, wherein the method comprises at least the following steps:
printing a paper in order to form a decor paper;
composing a stack to be pressed, comprising a substrate, said decor paper and one or more layers of synthetic material for forming a transparent or translucent layer above said decor paper, wherein the decor paper and the one or more layers of synthetic material substantially will form said top layer and at least one of said one or more layers comprises solid and/or hard particles;
hot-pressing said stack, wherein a consolidated whole of at least said substrate, said decor paper and said layers of synthetic material is created;
wherein said particles are provided on or in the respective layer of synthetic material by means of a strewing treatment, while the decor paper is already situated on the substrate.

22. The method of claim 12, 13, 20 or 21, wherein said substrate relates to a MDF or HDF board, and wherein the aforementioned decor paper has a surface weight of 80 grams per square meter or more in untreated and unprinted condition.
